(19) United States
(12) Patent Application Publication
(10) Pub. No.: US 2023/0088353 A1
(43) Pub. Date: Mar. 23, 2023

(54) ELECTROCHROMIC DEVICE AND METHOD FOR PRODUCING THE SAME

(71) Applicant: FRESHAPE SA, Villaz-St-Pierre (CH)

(72) Inventors: Yen-Cheng KUNG, Morges (CH); Marius CIOBANU, Palezieux (CH); Yuhang LIU, Bussigny (CH)

(21) Appl. No.: 17/800,793

(22) PCT Filed: Mar. 18, 2021
(86) PCT No.: PCT/EP2021/057023

§ 371 Date: Aug. 18, 2022

(30) Foreign Application Priority Data
Mar. 19, 2020 (EP) 20164333.5

(51) Int. Cl. G02F 1/1516; G02F 1/1506; G02F 1/1523; G02F 1/155; G02F 1/163

(52) U.S. Cl. CPC G02F 1/15165; G02F 1/1506; G02F 1/1525; G02F 1/155; G02F 1/163; G02F 2001/1555; G02F 2001/1635

(57) ABSTRACT

The present invention concerns an electrochromic device, a method for depositing an organic electrochromic material and a method for producing an electrochromic device. The device is preferably an electrochromic display, preferably a full-color electrochromic display. The device preferably comprises an electrodeposited organic electrochromic material and/or a polymeric organic electrochromic material.

### TECHNICAL FIELD

The present invention relates to an electrochromic device, in particular an electrochromic display, to a method for depositing organic electrochromic materials so as to provide pixels or subpixels of the electrochromic device, and to a method for producing the electrochromic device.

### BACKGROUND ART AND PROBLEMS SOLVED BY THE INVENTION

Electrochromic devices exploit the particular characteristics of electrochromic materials. Such materials, also called electrochromophores, can reversibly change their light absorbing characteristics when undergoing a redox reaction. In electrochromic devices, a system of opposing electrodes and an electrolyte is typically used so as to control the reversible and repeated oxidation and reduction of the electrochromic materials and to adjust the desired color displayed by the device. By applying an electric potential of the appropriate amount and sign between the electrodes the reduction or oxidation of the electrochromic material is achieved. An ion transport is mediated by the electrolyte so as to equilibrate charges at the electrodes.

Many different types of materials are reported to exhibit electrochromism. Examples of inorganic materials include certain metal oxides, such as tungsten-oxide (WO₃). An example of an organic electrochromic compound is viologen. US2017/0192334 discloses different derivatives of viologen having different colors, in particular derivatives having red, green and blue color are disclosed.

Electrochromic displays have certain properties that distinguish them from other displays, such as liquid crystal displays (LCD) or organic light emitting diode (OLED) displays. Electrochromic displays do not emit light themselves, but reflect or transmit the light of the environment in accordance with the color characteristics of the electrochromic material. As such, electrochromic displays are sometimes called “passive displays”. Continued use of an electrochromic display is considered to be less tiring to the human eye than light emitting, illuminating displays, such as the above-mentioned LCDs and OLED displays. Watching an electrochromic display corresponds more to watching a printed medium (reflecting light from the environment) than using a luminosity-based display.

Compared to LCDs and OLED displays, electrochromic displays exhibit a stronger contrast ratio, in particular when the ambient light intensity is high. Furthermore, electrochromic displays possess naturally a wide viewing angle, lower energy consumption and better light utilization efficiency. The electrochromic displays may thus be considered particularly advantageous for outdoor displays (ambient light) and for display-based reading (high contrast, less tiring to the human eye).

EP0084604, published in 1983, already discloses the use of an active matrix in electrochromic displays. The active matrix comprises a grid of conductive lines and a thin film transistors (TFTs), wherein said grid of conductive lines are disposed in rows and columns (X-Y matrix) so as to provide current flow selectively to any one of the TFTs and thereby configured to establish a voltage between the particular electrode that is in electric contact with the transistor and the counter electrode. In this configuration, the electrochromic material is deposited on the particular electrode electrically connected to the drain pad of the TFT elements. TFT panels or active matrices such as disclosed in this reference have been commercialized already since the 1980ies, where they were used to drive electroluminescent displays (EL) and LCDs. The scheme of an active matrix is also shown in FIG. 2A of US2007/0171148.

Full-color electrochromic displays can be produced by providing electrochromic materials of red, green and blue color, for example, on adjacent pixels, wherein each pixel (or sub-pixel) has an own electrode and can be addressed specifically by the active matrix. In this manner, a red-green-blue (RGB) additive color mixing system can be provided, wherein three-subpixels form a pixel. Such devices may comprise a grid barrier to isolate pixels from neighboring pixels.

Examples of electrochromic displays based in the RGB color mixing principle is disclosed in WO 2019/071733, where red, green and blue electrochromic materials are provided so as to form subpixels separated by an insulating separation part used so as to enable specific reduction/oxidation in the appropriate electrochromic (greed, red or blue) electrochromic material and probably to avoid cross-talk between subpixels. An electrolyte is not disclosed in this device, and it is difficult to understand how such a device can be manufactured and whether it is functional.

Another multi-color electrochromic display, according to the cyan-magenta-yellow (CMY) subtractive color mixing principle, is disclosed in US2005/0270619, which discloses pixel elements comprising superposed layers of yellow, magenta or cyan electrochrome layers. The materials in the different electrochrome layers require different voltages for inducing the colored state, so that, by adjusting the appropriate voltage across the pixel comprising the three electrochrome layers, it is possible to induce the colored state in one, two or all three of the three electrochrome layers.

U.S. Pat. No. 8,654,431 discloses a method for manufacturing an active matrix electrochromic device. The method comprises immersing a substrate comprising the active matrix in a solution comprising a metal oxide and forming an electrochromic metal oxide semiconductor layer by an electrophoretic process. Organic electrochromic materials may also be adsorbed to a surface of the electrochromic semiconductor layer. This reference requires the presence of cells for isolating the electrolyte of any pixel electrode from the electrolyte of any other pixel electrode. To this end, bank or wall structures for isolating pixels are provided. The bank structures are also used for covering the active material-based transistors. This document is silent with respect to how the organic electrochromic material can be deposited.

US 2007/0171148 discloses the deposition of an organic electrochromic material (a 4,4′-bipyridinium derivative compound) as a self-assembled mono-layer deposited from solution. U.S. Pat. No. 8,687,262 discloses deposition of an organic electrochromic compound by spin-coating.

More generally, for CMY subtractive color mixing, the stacking of three electrochromic layers and insulating layers in between is required as shown in US2005/0270619. The manufacturing process is rather complex. Also, the light intensity loss through the stacked layers diminishes the performance.

Regarding RGB additive color mixing, each pixel is composed of three subpixels, whose electrochromic layer should reflect or transmit red, green and blue light respectively. To fabricate full-color electrochromic devices using this color mixing principle, commonly a grid barrier to isolate the pixels and additional patterning process are suggested, usually including photolithography, for three different electrochromic materials. This renders the manufacturing process complex and expensive, too.

EP1347330A1 discloses an electrochromic display device including transparent pixel electrodes controlled by TFTs, a polymer layer made from an electrochromic material, and a solid electrolytic layer containing a coloring agent. In an example, this document discloses the electrodeposition of black polypyrole on ITO films.

U.S. Pat. No. 5,189,549 discloses an electrochromic device comprising pairs of side-by-side arranged electrodes face up on a substrate. Two electrochromic materials deposited as a pair of electrodes are complementary. In the fabrication of these particular devices, bus bars and electrodes are deposited on a substrate, and encapsulating layer is deposited in several steps, so as to protect the bus bars from subsequent manufacturing steps. As electrochromic materials, this document generally uses the combination of various materials, including the deposition by electropolymerization of poly-3-methylthiophene in combination with a WO₃ electrode pair.

JP2003315840 A discloses a full-color EC display, in which a nanoporous semiconductor layer is deposited on electrodes, and an electrochromic (EC) dye is adsorbed on the nanoporous layer. As nanoporous semiconductor materials, principally oxide semiconductors are mentioned, but also compound-semiconductors are disclosed, such as CuGaS₂, which may be formed by electrolytic deposition. The EC dye is said to be adsorbed by any one of several methods, including electric-field polymerization.

An objective of the present invention is to provide a full-color EC device, which can be obtained in a simple manufacturing method involving few steps. It is also an objective to provide an EC device having a rapid response time and ideally avoiding cross-talk between neighboring electrodes or pixels, and avoiding the inconveniences of solid electrolytes. It is an objective to provide an EC device that can be implemented using an active matrix.

The present invention addresses the problems and objectives indicated above.

### SUMMARY OF THE INVENTION

In an aspect, the present invention provides an electrochromic device comprising an organic electrochromic material, wherein said organic electrochromic material is selected from an polymeric organic electrochromic material, and electrodeposited organic electrochromic material, and both.

In an aspect, the present invention provides an electrochromic device comprising an active matrix comprising active components and electrodes connected to said active components, wherein said device further comprises an organic electrochromic material deposited so as to be in electric contact with said electrodes, wherein said organic electrochromic material is selected from an polymeric organic electrochromic material, and electrodeposited organic electrochromic material, and both.

In an aspect, the present invention provides an electrochromic device comprising pixels and/or subpixels, wherein said pixels and/or subpixels comprise a polymeric organic electrochromic material.

In an aspect, the present invention provides an electrochromic device comprising pixels, wherein said pixels and/or subpixels comprise an organic electrochromic material deposited by electrodeposition and/or electropolymerization.

In an aspect, the present invention provides an electrochromic device comprising an array or pixel electrodes and one or more counter electrode, wherein an organic electrochromic material is provided in electric contact with said array and/or pixel electrode and, wherein said organic electrochromic material is a polymeric organic electrochromic material and/or wherein said organic electrochromic material is an electrodeposited organic electrochromic material.

In an aspect, the present invention provides an electrochromic device comprising: a first electrode; an organic electrochromic material in electric contact with said first electrode; one or more counter electrode; and, a charge conducting material for transporting charges between said first electrode and said counter electrode; wherein said electrochromic device is configured to establish an electric potential between said first electrode and said one or more counter electrode, wherein said organic electrochromic material is an electrodeposited organic electrochromic material and/or an organic polymer electrochromic material, preferably obtained by electropolymerization.

In an aspect, the present invention provides an electrochromic device comprising:
a plurality of pixels, wherein each pixel comprises a pixel electrode and an organic electrochromic material, said organic electrochromic material is in electric contact with said pixel electrode;
a grid or matrix comprising electrically conducting lines, for providing electrical current to said pixel electrodes;
one or more counter electrode; and,
a ion conducting material for transporting ions between said pixels and said one or more counter electrode;

wherein said electrochromic display is configured to establish an electric potential between any one specific pixel electrode and said one or more counter electrode, characterized in that said organic electrochromic material is an electrodeposited organic electrochromic material and/or an organic polymer electrochromic material, preferably obtained by electropolymerization.

In an aspect, the present invention provides a method for depositing an organic electrochromic material so as to be in electric contact with an array electrode and/or pixel electrode, comprising the step of electrodepositing said organic electrochromic material and/or electropolymerizing said organic electrochromic material so as to be in electric contact with said array and/or pixel electrode.

In an aspect, the present invention provides a method for depositing an organic electrochromic material on a pixel electrode of an electrochromic device, the method comprising: providing a grid or matrix comprising electrically conducting lines and a plurality of pixel electrodes, wherein there is a specific line for each of said pixel electrode; immersing said grid or matrix in a solution; adding entities of an organic electrochromic material to said solution; providing a counter electrode in said solution; applying an electric potential between some or all of said plurality of pixel electrodes and said counter electrode, thereby providing the deposition of said entities of said organic electrochromic material on said pixel or subpixel electrode.

In some aspects, the invention provides methods for producing electrochromic devices, in particular electrochromic devices, which methods comprise depositing organic electrochromic materials on array and/or pixel electrodes in accordance with the invention.

In an aspect, the invention provides a method for producing an electrochromic device, the method comprising: depositing an organic electrochromic material on pixel electrodes of an electrochromic device in accordance with the invention or preferred embodiments disclosed herein; and, assembling a counter electrode and a charge transport material in order to provide said electrochromic device.

Further aspects and preferred embodiments of the invention are defined herein below and in the appended claims. Further features and advantages of the invention will become apparent to the skilled person from the description of the preferred embodiments given below.

Hereinafter, preferred embodiments of the device of the invention are described, in order to illustrate the invention, without any intention to limit the scope of the present invention.

### BRIEF DESCRIPTION OF THE DRAWINGS

FIG. 1 schematically shows an embodiment of an electrochromic display of the invention.

FIG. 2 schematically illustrates the deposition of organic electrochromic materials on pixel electrodes in accordance with an embodiment of the invention.

### DETAILED DESCRIPTION OF THE PREFERRED EMBODIMENTS

The present invention relates to electrochromic devices. Preferably, the electrochromic device comprises and/or consists essentially of an electrochromic display.

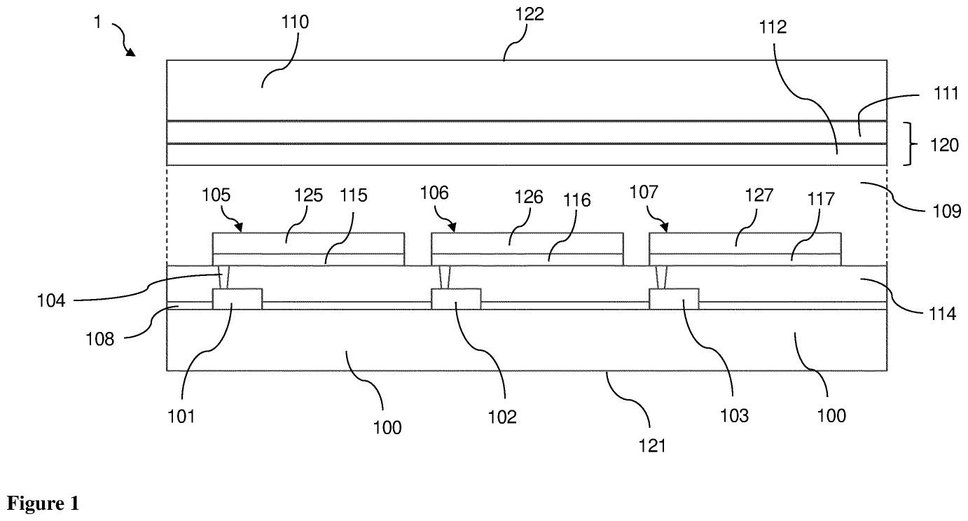

FIG. 1 schematically shows part an electrochromic display 1. The display 1 is overall flat and comprises two first and second support structures or substrates 100, 110, defining opposed first and second outside surfaces 121, 122. One or both substrates 100, 110 may be at least partially transparent. The substrates may comprise glass and/or at least partially transparent plastics, for example. Of course, at least one of the two substrates needs to be transparent, such that the device can function as a display.

For the purpose of the present specification, the expression “comprising” is intended to mean “contains, amongst other”. It is not intended to mean “consists only of”.

Conducting lines 108 (generally referred to as “conductor”) are provided on the inner surface of the first substrate 100. The conducting lines are electrically conductive. The conductor electrically connects an external driver (not shown in FIG. 1) with active components 101-103 of the display.

The active components 101-103 and the conductor 108 are preferably electrically isolated and protected by an electrical insulating layer 114, deposited on said active components and conductor 108. The conductor 108 preferably provides a plurality of conducting lines forming a grid or matrix.

In an embodiment, the electrochromic device comprises an insulating layer 114 provided between said first substrate 100 and said subpixel electrodes 115-117, wherein said active matrix comprises electrically conducting vias 104 extending across said insulating layer, wherein a via is provided to connect an individual active component 101, 102, 103 with an individual subpixel electrode 115, 116, 117. Preferably, said pixel or subpixel electrodes are deposited on said insulating layer.

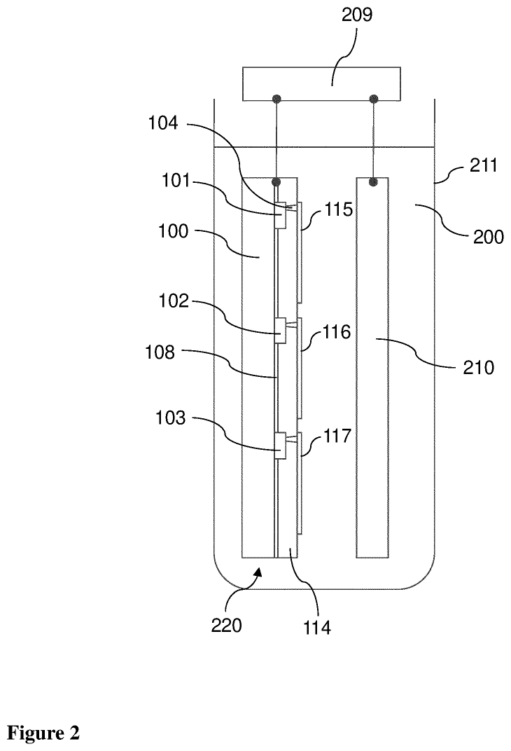

In an embodiment, the active components 101 are preferably transistors, for example thin film (TFTs) or circuits based mainly on TFTs. Together, all active components 101-103 may be an array of TFTs or TFT-based circuits electrically connected to the pixel electrodes 115-117 of the display. The conducting lines 108 and active components 101-103 preferably provide a grid, array or matrix that may be referred to as “an active-matrix”. It is noted that the conducting lines 108 are preferably provided in such a manner that each active component 101-103 can be individually and/or independently addressed. Preferably, each active component 101-103 can be individually and/or independently provided with current and/or exposed to a voltage potential, as disclosed, for example, in EP0084604 (FIG. 3) and in US 2007/0171148 (FIG. 2A).

Typically, each active component 101-103 comprises a gate electrode, a source electrode and a drain electrode. Typically, the cathode of each array electrode 115-117 or of each pixel is connected to the drain electrode, preferably by via 104. The via 104 is also conductive and may be considered as a conductive connection between the active components, provided on the first substrate, and the pixel electrodes 115-117, provided on the insulating layer 114, such that the via provides a connection between different layers of the device, in particular between the opposed surfaces of the insulating layer 114.

It is noted that the term “active-matrix” should not be confused with the notion of electrochromic displays being “passive displays”. The latter expression refers to the fact that electrochromic displays generally does not generate light, but comprise electrochromic materials that may be controlled so as to have a particular color and therefore reflect light of a particular color. The term “active-matrix” refers to the electronic matrix comprising conducting lines 108 and active components 101-103 that are used to supply current to array electrodes and/or to pixels and/or to expose pixels to a voltage potential.

In an embodiment, the grid, array and/or matrix comprises an active matrix.

The active matrix preferably comprises active components 101-103, wherein an active component 101, 102, 103 is provided for each array electrode 115-117 and/or for each of said pixels 105-107, wherein said one active component 101-103 is electrically connected to one pixel electrode 115-117 and wherein a predetermined pixel electric potential is established via said active component 101.

In an embodiment, said grid, array and/or matrix comprises thin film transistors (TFTs), wherein every pixel or subpixel of said electrochromic device comprises at least one TFT for controlling current flow towards or from a pixel or subpixel electrode.

For the purpose of the present specification, the term “pixel electrode” is exchangeable with the terms “array electrode” and the two terms refer to the same structural features 115-117. Similarly, the term “array electrode” may also replace the term “subpixel electrode” as disclosed elsewhere in this specification.

The display shown in FIG. 1 preferably comprises a plurality of pixels 105-107. Preferably, each pixel comprises a pixel electrode 115-117 and an electrochromic material 125-127. The electrochromic material preferably comprises or consists of an organic electrochromic material 125-127.

Preferably, said organic electrochromic material 125-127 is in electric contact with said pixel electrode 115-117.

For the purpose of the present specification, the expression “electrically connected” or “in electric contact” means that steady current (electrons, holes) flow occurs between the items that are electrically connected under fixed potential difference.

In an embodiment, the pixel electrodes 115-117 are preferably at least partially transparent to visible light. In an embodiment, the pixel electrodes 115-117 comprise and/or consist essentially of transparent conductive materials, preferably transparent conductive oxides (TCOs) which may be selected, for example, from the group consisting of indium tin oxide (ITO), fluorine doped tin oxide (FTO), antimony-doped tin oxide (ATO), tin oxide (SnO), zinc oxide (ZnO), aluminium doped zinc oxide (AZO) or indium zinc oxide (IZO).

In a preferred embodiment, the pixel electrodes 115-117 also comprise a nanostructured layer, preferably deposited on and/or on top of said conductive materials, preferably transparent conductive materials as listed above (ITO; FTO, etc). Preferably, the organic electrochromic materials 125-127 are deposited on said nanostructured layer. The nanostructured layer may comprise a metal oxide material. The nanostructured layer may comprise a semiconductor and/or conducting material. The nanostructure layer may be nanoporous. Preferably, the nanostructured layer may be selected from TCOs for example as exemplified above (ATO, ITO, SnO, ZnO, etc), and also from titanium dioxide (TiO₂).

In an embodiment, a first pixel 105 comprises a first pixel electrode 115 and a first electrochromic material 125, a second pixel 106 comprises a second pixel electrode 116 and a second electrochromic material 126, a third pixel 107 comprises a third pixel electrode 117 and a third electrochromic material 127, and so forth, the nth pixel comprising an nth pixel electrode and an nth electrochromic material. Preferably, said electrochromic material comprises or consists of an organic material, as described in further detail elsewhere in this specification.

When considering the overall electrochromic device comprising many pixels and/or subpixels, reference numerals 105, 106, 107 may also be used to refer to first, second and third portions of pixels or subpixels, respectively. By analogy, reference numerals 115, 116, 117 may be understood as first, second and third portions of pixel (or subpixel or array) electrodes.

The electrode 115-117 of each pixel 105-107 is electrically connected with a vial 104 to the active component 101-103 provided for the specific electrode. For example, the through vials 104 cross the protective and/or insulating layer 114, so as to electrically connect an active component with its corresponding pixel electrode.

While FIG. 1 shows three pixels 105-107, it is understood that the device of the invention preferably comprises many more pixels. Three pixels are shown for the purpose of illustration.

In an embodiment, the electrochromic materials 125-127 are provided on top of the corresponding pixel electrode 115-117, that is the first electrochromic material 125 is on top of the first pixel electrode 115, and so forth.

In an embodiment, the pixel electrodes 115-117 are provided, for example deposited, in the forms of layers.

In an embodiment, the electrochromic materials 125-127 are provided, for example deposited, as layers.

In an embodiment, the electrochromic materials 125-127 are provided, preferably deposited, so as to cover the pixel electrode of the corresponding pixel 105-107. Preferably, the pixel electrode is covered completely by said electrochromic material. Preferably, the pixel electrode materials 115-117 are not in contact with the ion transport material 109. If the pixel electrode is completely surrounded or covered by the electrochromic material, the efficiency of charge injection for colouring or bleaching may be higher. However, the device should also work if the pixel electrode is not completely covered and/or comprises surfaces that are in contact with the ion transport layer.

As can be understood, the electrochromic material associated with a corresponding pixel electrode is in electrical contact with that pixel electrode, preferably only with the corresponding pixel electrode. For example, the first electrochromic material 105 is in electrical contact, preferably in physical contact, with the first pixel electrode 115, and so forth.

As can be understood, the electrochromic material associated with a corresponding pixel electrode is preferably in direct physical contact with that pixel electrode, preferably only with the corresponding pixel electrode. This is preferably the consequence of the deposition of the electrochromic material directly on the corresponding pixel electrode, as will be described in more detail elsewhere in this specification.

The device 1 of the invention preferably comprises at least one counter electrode 120. The counter electrode 120 is preferably in contact with the second substrate 110. Preferably, at least part of the counter electrode is directly deposited on the inner surface of the second substrate 110.

In an embodiment, the at least one counter electrode 120 is preferably at least partially transparent to visible light. In an embodiment, the at least one counter electrode 120 comprises and/or consists essentially of transparent conductive materials, such as transparent conductive oxides (TCOs), which may be selected, for example, from the group consisting of indium tin oxide (ITO), fluorine doped tin oxide (FTO), antimony-doped tin oxide (ATO), tin oxide (SnO), zinc oxide (ZnO), aluminium doped zinc oxide (AZO) or indium zinc oxide (IZO). Preferably, the conductive material forms a layer 111 of the device of the invention, preferably on the inner surface of said second substrate 110.

In a preferred embodiment, and as shown in FIG. 1, the counter electrode 120 comprises a comprises a conductive layer 111.

In a preferred embodiment, and as shown in FIG. 1, the counter electrode 120 comprises an ion storage layer 112.

In a preferred embodiment, the counter electrode 120 comprises a conductive layer 111 and a ion storage layer 112.

The device 1 of the invention preferably comprises at least one ion storage layer 112. In an embodiment, the ion storage layer 112 is deposited on the conductive layer 111. In an embodiment, the ion storage layer 112 comprises or consists essentially of a porous structure, preferably a nanoporous and/or nano-crystalline structure. Preferably, the porous structure is such that the electrolyte can percolate into the body, and ions can gather at the surface of the porous structure, preferably also inside the body of the ion storage layer. In other embodiments, the ion storage layer may be a compact and/or non-porous layer. It is expected that a compact ion storage layer has a smaller overall surface available for ions to gather and therefore a lower overall storage capacity. However, devices comprising compact ion storage layers do also work.

Preferably, the ion storage layer 112 is provided so as to have the appropriate ion storage capacity. The ion storage layer may be selected from the group consisting of: of conductive inorganic materials with high surface area, for example, mesoporous structure, nanowire and nanotubes. The ion storage layer 112 may typically comprise or consist essentially of a doped metal oxide, such as antimony tin oxide (ATO). The ion storage layer 112 may also be selected from the group of conductive polymers with porous structure, or from the group of conductive hybrids of inorganic and organic materials.

In an embodiment, the device 1 of the invention preferably comprises an ion conducting material 109 for transporting ions between said pixels 105-107 and said one or more counter electrode 120. The ion conducting material 109 is preferably provided for enabling and/or mediating transport of ions, such as charged molecules or other (e.g. metal) ions. The ions may be cations or anions. The ions may be organic or inorganic.

Accordingly, the ion conducting material 109 is preferably an electrolytic layer and/or an electrolyte, such as an electrolyte comprising dissolved ions and/or an ionic liquid. In preferred embodiments, the ion conducting material 109 may be selected, for example, from liquid electrolytes, gel-like electrolytes, ionic liquids, and eutectic melts.

In an embodiment, the ion transport material 109 comprises one or more cations selected from lithium, sodium, potassium, alkylimidazolium, alkylpyridinium, alkylphosphonium alkylammonium and tetra-n-buthylammonium. Preferably, said alkyl is C1-C20 alkyl, more preferably C1-C10 alkyl, most preferably C1-C4 alkyl, for example methyl.

In an embodiment, the ion transport material 109 comprises a salt of any one of the aforementioned cations.

In an embodiment, the ion transport material 109 comprises one or more anions selected from bistriflimide or TFSI ([(CF₃SO₂)₂N]⁻), perchlorate (ClO₄⁻), tetrafluoroborate (BF₄⁻), or hexafluorophosphate (PF₆−).

In an embodiment, the ion transport material 109 comprises a salt of any one of the aforementioned anions.

In an embodiment, the ion transport material 109 comprises one or more salts comprising at least one of the aforementioned anions and at least one of the aforementioned cations.

In a particular embodiment, the ion transport material 109 comprises one or more selected from LiTFSI, LiClO₄, LiBF₄ or LiPF₆.

In an embodiment, the ion transport material 109 comprises at least one solvent. The solvent may be selected, for example, from propylene carbonate, ethylene carbonate, tetrahydrofuran, dioxane, dimethyl sulfoxide, dimethylformamide, acetonitrile sulfolane, γ-butyrolactone and solvent mixtures comprising one or more of the aforementioned solvents. It is noted that in certain electrolytes, such as ionic liquids (also known as ionic melts or liquid salts), a separate solvent may be absent, as the ionic liquid functions as solvent and also provides the ions for ion transport.

In an embodiment, the ion transport material 109 comprises at least one solvent, at least an anion and at least a cation. In an embodiment, the ion transport material 109 comprises at least one or more selected from a salt of at least one of the aforementioned cations and a salt of at least one of the aforementioned cations, and, optionally, a solvent preferably selected from the aforementioned solvents.

In an embodiment, the electrolytic layer 109 can be a liquid, a gel, or a solid

In a preferred embodiment, the electrolytic layer 109 preferably comprises and/or consists essentially of a liquid crystal or ionic liquid crystal. Such liquid crystals and/or ionic liquid crystals are advantageous as they may contribute to reducing crosstalk effect between pixels.

In an embodiment, the ion conducting material 109 is provided within a common space, wherein several pixels and/or subpixels 105-107 are provided preferably within said common space and/or are in contact with a continuous and/or homogenous ion conducting material 109, preferably within said continuous space. This is illustrated in FIG. 1, where reference numeral 109 also refers to said common space, as this space is filled with the ion conducting material 109, preferably said electrolyte as disclosed herein.

The ion conducting material preferably has consistent and/or invariant electric properties within said common, continuous space.

In an embodiment, the device of the invention comprises an insulating layer 114 for electrically separating the ion conducting material 109 from said grid or matrix comprising electrically conducting lines 104, 108 and/or from said active components 101-103, if present.

Preferably, the device of the invention does not comprise separation walls or separation parts for separating the pixels and/or subpixels. Preferably, the device lacks separation walls, parts, borders and/or regions parts for separating the pixels and/or subpixels. Such separations are provided, in the prior art, for electrically separating adjacent pixels and/or adjacent subpixels, essentially for avoiding cross-talk between electrodes. The above separation elements may be used in the prior art to prevent a continuous ion conducting material that is in contact with different, e.g. neighboring pixels.

This feature, amongst others, distinguishes the device of the invention from prior art devices, such as disclosed in WO2019/071733, U.S. Pat. No. 8,654,431, US2017/0192334, and others, in which pixels (or subpixels) are separated by separation walls and each pixel (or subpixel) comprises an own, confined electrolyte.

Preferably, a continuous conducting material 109 (e.g. electrolyte) is in physical contact with several different, for example neighbouring pixels and/or neighbouring array electrodes 115-117. In an embodiment, the ion conducting material 109 (e.g. electrolyte) is in physical contact with the electrochromic materials 125-127 deposited on different, preferably neighbouring array electrodes 115-117. Cross-talking during operation of the device is preferably prevented through the use of the ion transport material 109.

In a preferred embodiment, the ion conducting material 109 comprises a liquid crystal. U.S. Pat. No. 8,687,262 discloses the use of liquid crystals so as to avoid the cross-talk between pixels. In an embodiment, the ion transport material 109 comprises an electrolyte and a low-molecular liquid crystal material as disclosed in U.S. Pat. No. 8,687,262.

Although the conducting materials 105-107 are indicated to be pixel electrodes, it is correct to consider the combination of a pixel (or subpixel or array) electrode 115 (and 116-117) and the electrochromic material 125 (126-127) deposited thereon together as a first electrode or pixel electrodes. In other words, the term pixel used herein with respect to the structure encompassed by reference numerals 105-107 may also be understood as pixel electrode or first electrode, since the whole structure 105 may be considered as an electrode.

One may also consider all pixels 105-107 as a whole (including up the n pixels not shown) as the first electrode and the combination of layers 111 and 112 as counter electrode 120. The invention thus encompasses different wordings or nomenclature that may be used in the literature for designating the electrode and counter electrode.

The invention also encompasses the possibility of providing an electrochromic material on or in electric and/or physical contact with the counter electrode 120, more specifically with the ion storage layer 112. For example, electrochromic materials deposited on or as part of the counter electrode 120 may be selected from inorganic and/or organic materials as disclosed in US 2007/0192334, for example. An electrochromic material may also be part and thus comprised in the counter electrode. Such an electrochromic material is preferably different from the electrochromic material 125-127 generally disclosed in the present application as being associated with the pixel electrodes 115-117.

In a preferred embodiment, the electrochromic material 125-127 comprises or consists essentially of one or both selected from the group consisting of: an electrodeposited organic electrochromic material and an organic polymer electrochromic material.

In an embodiment, the electrochromic material 125-127 comprises an organic or hybrid material comprising one or more selected from said electrodeposited organic electrochromic material and/or organic polymer electrochromic material. For the purpose of the present specification, a “hybrid material” is a material comprising one or more inorganic and one or more organic materials. In the case of hybrid materials, the organic electrochromic material preferably provides at least one organic component of said hybrid material.

In an embodiment, the electrodeposited organic electrochromic material and/or the organic polymer electrochromic material is preferably selected from doped and/or undoped organic materials. If the organic material is doped, it may comprise non-organic components or additives, such as metal ions, organometallic materials and composite materials, for example.

In a preferred embodiment, the electrodeposited organic electrochromic material and/or the organic polymer electrochromic material is obtained by electropolymerization.

In an embodiment, said electrodeposited organic material comprises one or more selected from electrodeposited heterocycles. Heterocycles may be aromatic or not. Examples of heterocycles are viologen, thiophene, pyridine, anthraquinone, imides, pyridine, and derivatives of the above, in particular compounds comprising these structures and optionally further comprising substituents as detailed herein below. The electrochromic material may comprise an organic material obtained by the electropolymerization of a heterocyclic compound and their derivatives. The electrochromic material may comprise a polymeric heterocycle.

In a preferred embodiment, said electrodeposited organic material 125-127 comprises one or more selected from the group consisting of: electrodeposited viologen, electrodeposited triphenylamine, electrodeposited thiophene, electrodeposited 3,4-ethylenedioxythiophene, electrodeposited pyridine, electrodeposited aniline, electrodeposited imides, electrodeposited aromatic ketones, electrodeposited anthraquinone, electrodeposited amides, electrodeposited norbornene-based compounds, electrodeposited carbazoles, electrodeposited thiocarbazoles, electrodeposited pyrol, and electrodeposited derivatives of the indicated compounds. Derivatives of the indicated compounds include in particular the indicated compounds in which one or more hydrogen may optionally be substituted with substituents as specified herein below, for example.

In an embodiment, the electrochromic materials 125-127 can be formed through electropolymerization of, for example, viologen-, triphenylamine-, thiophene-, 3,4-ethylenedioxythiophene-, pyridine-, pyrol-, aniline-, imide-, aromatic ketone, anthraquinone-, amide-, norbornene-, carbazole-, and thiocarbazole, including derivatives of any one or more of the aforementioned. Derivatives of the indicated compounds include in particular the indicated compounds in which one or more hydrogen may optionally be substituted with substituents as specified herein below.

In an embodiment, the electrochromic materials 125-127 can be formed through electropolymerization of, for example, viologen-based compounds, triphenylamine-based compounds, thiophene-based compounds, 3,4-ethylenedioxythiophene-based compounds, pyridine-based compounds, pyrol-based compounds, aniline-based compounds, imide-based compounds, aromatic ketone-based compounds, anthraquinone-based compounds, amide-based compounds, norbornene-based compounds, carbazole-based compounds, and thiocarbazole-based compounds.

The expression “-based compounds” or “-based organic material” as used in this specification meant to encompass the structure of the indicated compound or material as well as derivatives thereof, which derivatives comprise the basic structure of the indicated compound or material. For example, such compounds may further comprise one or more optional substituents as indicated herein below. For example, the expression “viologen-based compounds” preferably encompasses compounds that comprise the basic structure of viologen, but which may further comprise one or more substituents that may affect the color and/or electrochromic characteristics or properties of the compound.

In a preferred embodiment, said polymerized organic material 125-127 comprises one or more selected from the group consisting of polyviologen, polytriphenylamine, polythiophene, poly(3,4-ethylenedioxythiophene) (PEDOT), polypyridine, polypyrol, polyaniline, polyimides, polymeric aromatic ketones, polyanthraquinone, polyamides, polynorbornene, polycarbazoles, polythiocarbazoles, and their derivatives.

In an embodiment, said polymerized organic material 125-127 comprises one or more selected from the group consisting of a polyviologen-based organic material, a polytriphenylamine-based organic material, a polythiophene-based organic material, a polypyridine-based organic material, a polypyrol-based organic material, a polyaniline-based organic material, a polyimide-based organic material, a polymeric aromatic ketone-based organic material, a polyanthraquinone-based organic material, a polyamide-based organic material, a polynorbornene-based organic material, a polycarbazole-based organic material, and a polythiocarbazole-based organic material.

An example of a polythiophene-based organic material is a poly(3,4-ethylenedioxythiophene) (PEDOT)-based organic material.

As indicated derivatives of the aforementioned materials are also encompassed. For example, the expression “electrodeposited viologen” encompasses an electrodeposited derivative of viologen comprising the basic structure of viologen, and furthermore one or more optional substituents. The expression “polyviologen” encompasses a polymer of a monomers that comprise the basic structure of viologen and which monomers may be derivatized viologen so as to comprises one or more optional further substituents, for example. For example, US20070171148 discloses derivatives of viologen, where substituents of the viologen basic structure may be selected so as to provide a viologen derivative having particular color characteristics.

Optional substituents of the above referenced organic materials, in particular said exemplified electrodeposited materials, said polymerized organic materials may be selected from organic substituents comprising from 1-50 carbons and 0-20 heteroatoms, preferably 1-20 carbons and 0-10 heteroatoms, most preferably 1-10 carbons and 0-5 heteroatoms.

In some embodiments the substituents may be selected from aliphatic and aromatic substituents, esters and amines of aliphatic and aromatic moieties, wherein in said aliphatic or aromatic substituent or moiety one or more hydrogens are optionally replaced independently by one or more selected from phosphonate (—PO(OH)₂), boronic acid (—B(OH)₂), —OH, —COOH, —NH₂, —NO₂, aminoxide (—N⁺(R)₂—O⁻), halogen, and —(CH₂)ₙ—Si(OR₃)₃. R and R₃ are independently selected from C1-C10 alkyl, preferably C1-C5 alkyl.

It is noted that said replaced hydrogen may be a hydrogen attached to a carbon or to a heteroatom, such as nitrogen of the basic organic material as mentioned above, for example. The latter applies preferably if the substituent comprises a C-atom, which is connected to said heteroatom.

In an embodiment, the substituents are selected from linear or branched alkyls, alkenyls, alkylaryls, and alkylarylalkyl (e.g. alkylphenylalkyl, such as alkylbenzyl), in which one or more hydrogens are optionally replaced independently by one or more selected from —PO(OH)₂, —B(OH)₂, —OH, —COOH, —NH₂, —NO₂, aminoxide (—N⁺(R)₂−O⁻), halogen, and —(CH₂)ₙ—Si(OR₃)₃. R and R₃ are independently as defined above.

In an embodiment, optional substituents of the above indicated organic materials may be independently selected from:

C₁₋₁₀ alkyl, N-oxide, dimethylamino, acetonitrile, benzyl, phenyl, benzyl, which is mono- or di-substituted by nitro; phenyl, which is mono- or di-substituted by nitro, and from the substituents of formulae (1)-(9):

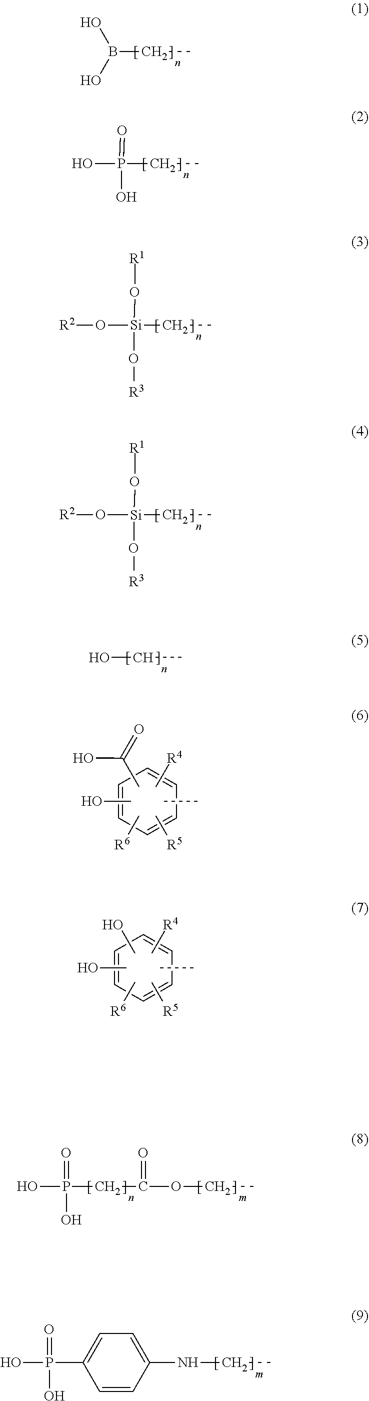

wherein n and m are, independently, an integer of 1-10,

R₁-R₃ are independently selected from C1-C10 alkyl,

R₄-R₆ are independently selected from hydrogen, C1-C10 alkyl, C2-C10 alkylene, aryl, substituted aryl, halogen, nitro, and —OH, and wherein the dotted line represents the single bond by which the substituent is connected to the basic structure of the indicated organic material, compound or monomer, as applicable.

Substituent (8) is an example of a substituent comprising an ester comprising aliphatic and aromatic moiety.

The electrochromic material preferably has a particular color depending on the oxidation status of the material. In some embodiments, the electrochromic material has no color when being in a first oxidation (or redox) state, and has a particular color (preferably red, green or blue) when being in a second oxidation state. In the device of the invention, the oxidation state of the electrochromic material is preferably controlled by the voltage to which the material is exposed via the arrangement of pixel electrodes and the counter electrode. One may also say that the flow of current through via 104, is preferably controlled or adjusted by the active components 101-103. The current through via 104 is preferably used to oxidize and/or reduce the electrochromic material so as to give it the color that it is wished to have at a particular moment. The current flow is preferably the result of the voltage applied by the pixel electrode and counter electrode arrangement within the device. The ion flow within the ion transport material 109 preferably equilibrates the accumulated charges at both electrodes.

These electrodeposited and/or polymeric organic electrochromic materials are preferably deposited in accordance with the method of the invention, as will be disclosed in some more detail elsewhere in this specification.

In an embodiment, the device of the invention is an electrochromic color device, preferably a electrochromic color display. Preferably, the device is a multi-color electrochromic device, most preferably full-color electrochromic device. Preferably, the device is a display, in particular a multi-color electrochromic display, most preferably full-color electrochromic display.

In an embodiment, the color-characteristics of the device are provided at least in part by the presence of organic electrochromic materials of different color. In a preferred embodiment, neighbouring pixels, preferably subpixels, comprise electrochromic materials of different color, preferably of the colors red, green and blue (RGB colors).

Preferably, the device of the invention is based on RBG color mixing.

Referring to FIG. 1 in view of the color device, one of pixels 105-107 preferably comprises a red electrochromic material, one preferably comprises a green electrochromic material and one a blue electrochromic material. As mentioned above, said electrochromic materials preferably comprise and/or consist essentially of polymeric organic electrochromic materials and/or electrodeposited organic electrochromic materials.

In a particular embodiment, a first pixel 105 comprises a red organic electrochromic material 125, a second pixel 106 comprises a green electrochromic material 126, and a third pixel 107 comprises a blue organic electrochromic material 127.

In a full-color device, pixels 105-107 may be considered as subpixels, which together provide one pixel and/or color, preferably by additive RBG color mixing. In this case, subpixels 105-107 form one pixel of the electrochromic device. In this case, each subpixel, comprises a subpixel electrode 115-117, for example a first subpixel 105 comprises a first subpixel electrode 115, a second subpixel 106 comprises a second subpixel electrode 116, and a third subpixel 107 comprises a third subpixel electrode 117.

Preferably, said subpixels 105-107 forming a pixel have the structure and/or are made from the materials as described herein above. For example, the subpixel electrodes 115-117 may comprise a nanostructured layer as detailed above. Preferably, the electrochromic materials of said subpixels comprise an organic electrodeposited and/or an organic polymeric electrochromic material, preferably selected from the materials set out elsewhere in this specification.

In a preferred embodiment, the electrochromic device 1 is a full-color electrochromic device, comprising pixels comprising first, second and optionally third subpixels 105, 106, 107, each subpixel comprising a subpixel electrode 115-117 and each first, second and optionally third subpixel comprising an organic electrochromic material 125-127 having a different color.

The skilled person will understand that the subpixel electrodes 115-117 of the subpixels may be and preferably are identical and/or made from the same material. In an embodiment, the electrochromic materials 125-127 is the main or sole difference between the subpixels 105-107. It is noted that the (array or pixel) electrodes 115-117 may be considered to be part of the active matrix. Therefore, the (array or pixel) electrodes 115-117 are preferably part of both, the pixels (or subpixels) 105, 106, 107 and of the active matrix.

In a preferred embodiment of the electrochromic device 1, said first subpixel 105 comprises an organic electrochromic material 125 having a red color when exposed to a particular voltage, said second subpixel 106 comprises an organic electrochromic material 126 having a green color when exposed to a particular voltage, and said optional third subpixel 107 comprises an organic electrochromic material 127 having a blue color when exposed to a particular voltage.

In a preferred embodiment, three subpixels 105, 106, 107 are provided adjacently, next to each other. Preferably, electrochromic materials of different color are provided next to each other, on spaced-apart subpixels. Preferably, said subpixels are not in direct physical contact with each other. Preferably, the different electrochromic materials (having also different color characteristics) are not in direct physical contact and are not superimposed. Preferably, this embodiment distinguishes the device of the invention from devices comprising superimposed electrochromic materials, as shown, for example, in US2005/0270619.

Preferably, said spaced-apart subpixels (or pixels) 105-107, and thus the corresponding electrochromic materials 125-127 are laterally and/or horizontally spaced apart, where horizontal is defined by the plane of the overall generally flat electrochromic device. More specifically, one or both substrates 100 and 110 preferably extend in planes that are parallel to horizontal. Preferably, the pixels (or subpixels) 105-107 lie in or on a same horizontal plane. Preferably, the electrochromic materials 125-127 of different, in particular neighbouring, pixels or subpixels, as the case may be (i.e. subpixel in color devices) lie in a same horizontal plane. In an embodiment, the majority, preferably all pixels and/or subpixels of the device are provided in and/or aligned in the same plane.

Preferably, neighboring subpixels of the different RBG colors are provided side-by side on the insulting layer. Preferably, three subpixels providing together a color by RBG color mixing are aligned in the same plane, which plane is substantially parallel with respect to at least one of the two opposed surfaces 121, 122 of the device. For example, the plane of the subpixels is defined by the surface of the insulating layer on which the pixel or subpixel electrodes are deposited.

In a preferred embodiment, said ion conducting material 109 is provided within a common space, wherein at least three separate subpixels 105, 106, 107, are provided preferably within said common space and/or are in contact with a continuous ion conducting material 109.

In a preferred embodiment, said grid or matrix comprises an active matrix comprising active components 101-103, wherein an active component 101, 102, 103 is provided for each of said subpixels 105-107, wherein said one active component 101-103 is electrically connected to one subpixel electrode 115-117, and wherein a predetermined subpixel electric potential is established via said active component 101.

The device of the invention preferably comprises an external driving component and/or terminal (not shown in FIG. 1). This driving component is configured to provide the appropriate voltage potential independently with respect to each pixel or subpixel, so as to create the oxidations states of the electrochromic materials that will make it possible to overall produce an image by way all pixels or subpixels together.

In an embodiment, the first substrate 100, the electrical insulating layer 114, the pixel electrodes 115-117, the electrolytic layer 109, the second substrate 110, the counter electrode 111, and the ion storage layer 112 may be transparent, providing a transparent electrochromic display, so that the users can perceive the images from both sides of the display and keeping the object behind the display visible.

In another embodiment, the first substrate 100, the electrical insulating layer 114, the pixel electrodes 115-117, and the electrolytic layer 109 may be transparent, and the ion storage layer 112 may be diffusively reflective, providing a reflective electrochromic display with white background. The users can perceive the images from the pixel electrode side 121.

In yet another embodiment, the second substrate 110, the counter electrode 111, and the ion storage layer 112, and the electrolytic layer 109 may be transparent, and the electrical insulating layer 114 may be diffusively reflective, providing a reflective electrochromic display with white background. The users can perceive the images from the counter electrode side (side 122).

The invention also relates to a method for depositing an organic electrochromic material 125-127 on pixel electrodes 115-117 of an electrochromic device. The method of the invention is illustrated in FIG. 2. The organic electrochromic materials may be the same materials as disclosed elsewhere in this specification. The array electrodes 115-117 may also be pixel or subpixel electrodes, for example in a color electrochromic device, such as a color display, as disclosed elsewhere in this specification.

The method of the invention preferably comprises providing a grid or matrix comprising electrically conducting lines and/or vias 104, 108 and a plurality of pixel electrodes 115-117, wherein there is a specific via 104 for each of said pixel electrode 115-117. Active matrices that may be used for the purpose of the method of the invention are now commercially available and have been disclosed, for example, in EP0084604 and US20070171148. In FIG. 2, the active matrix is indicated with reference numeral 220. The active matrix is preferably the active matrix as contained in the device of the invention, for example as shown in FIG. 1. Therefore, reference numerals 100-108, 114-117, which refer to components or constituents of the active matrix 220, preferably have the same meaning as disclosed above with respect to FIG. 1. The array electrodes 115-117 may also be seen as part of the active matrix.

The method of the invention preferably comprises immersing said grid or matrix in a solution 200. In FIG. 2, the active matrix 220 has been immersed in chemical bath 200.

The method of the invention preferably comprises adding entities of an organic electrochromic material to said solution. Said entities are preferably organic molecules that can be deposited by electrodeposition and/or that can be polymerized by electropolymerization, preferably both. Preferably, said entities are monomers of said organic electrochromic materials 125-127.

In an embodiment, said entities of an organic electrochromic material are the monomers of one or more selected from the group consisting of: polyviologen, polytriphenylamine, polythiophene, polypyridine, polypyrol, polyaniline, polyimides, polymeric aromatic ketones, polyanthraquinone, polyamides, polynorbornene, polynorbornene-based compounds, polycarbazoles, polythiocarbazoles, and their derivatives.

In an embodiment, the monomers of these polymers may carry the optional substituents as disclosed elsewhere in this specification, which substituents may be used to adjust the electrochromic characteristics of the resulting polymer. As indicated herein above, such substituents may be selected from organic substituents comprising from 1-50 carbons and 0-20 heteroatoms, preferably 1-20 carbons and 0-10 heteroatoms, most preferably 1-10 carbons and 0-5 heteroatoms.

As indicated herein above, such substituents may be selected from aliphatic and aromatic substituents, esters and amines of aliphatic and aromatic moieties, wherein in said aliphatic or aromatic substituent or moiety one or more hydrogens are optionally replaced by one or more selected from phosphonate (—PO(OH)₂), boronic acid (—B(OH)₂), —OH, —COOH, and —(CH₂)ₙ—Si(OR₃)₃. R₃ is an C1-C10 alkyl, preferably C1-C5 alkyl. Further embodiments as detailed herein above with respect to the substituents apply to the substituents contained on the monomeric moieties (e.g. C₁₋₁₀ alkyl, N-oxide, dimethylamino, acetonitrile, benzyl, phenyl, benzyl, which is mono- or di-substituted by nitro; phenyl, which is mono- or di-substituted by nitro, and from the substituents of formulae (1)-(9), and so forth.

It is noted that the entities may be added to the solution before, after or at the same time of immersing said grid or matrix 220 in the solution 200. The solution may be a solution that already contains the entities of an organic electrochromic material. The skilled person understands that the goal is to achieve the configuration schematically illustrated in FIG. 2, whereby the order of adding components is generally not relevant.

This also applies for immersing a counter electrode 210 in said solution 200 in accordance with the method of the invention.

The previous method features may also be referred to more generally as providing a recipient 211 comprising an active matrix 220, a counter electrode 210 and a solution 200 comprising entities (preferably monomers) of an organic electrochromic material, as illustrated in FIG. 2.

The method of the invention preferably comprises applying an electric potential between some or all of said plurality of pixel electrodes 115 and said counter electrode 210, thereby providing the deposition of said entities of said organic electrochromic material on said pixel or subpixel electrode 115. Preferably, the active matrix 220 is electrically connected to the external driver 209. Preferably, the counter electrode 210 is also electrically connected to the external driver 209 or possibly to another power source or to an electrode terminal of the active matrix, as illustrated in U.S. Pat. No. 8,654,431 (FIG. 5), for example.

The driver 209 is preferably configured to be suitable to control the current flow to the pixel electrodes 115-117 and/or to the counter electrode 210, and/or to establish a desired voltage potential between said pixel electrodes 115-117 and/or to the counter electrode 210. Preferably, the driver 209 can address independently and individually each active component 101, 102, 103 and thus each pixel or subpixel electrode 115, 116, 117. In another embodiment, the driver 209 can address independently and individually one group 115 out of several groups 115-117 of pixel or subpixel electrodes.

By applying a voltage potential between all pixel electrodes 115-117 and the counter electrode 210 in said solution, the organic entities will migrate to the pixel electrodes 115-117 and be electrodeposited and/or electropolymerized on all said pixel electrodes.

In a preferred embodiment, said entities of an organic electrochromic material are monomeric entities, and wherein an organic electrochromic material is formed upon deposition of said monomeric moieties on said pixel electrodes 115. Preferably, a polymeric organic electrochromic material is formed upon deposition of said monomeric moieties.

In a preferred embodiment, the method of the invention comprises the electrodeposition and/or electropolymerization of said entities of said organic electrochromic material on said pixel electrode 115.

Preferably, the polymer is preferably formed in situ, on the respective pixel or subpixel electrode, as is preferably determined by the driving device.

In a preferred embodiment, the method comprises providing an external driving device 209, configured to apply said electric potential between said plurality of pixel electrodes 115 and said counter electrode 210, thereby providing the deposition of said entities of said organic electrochromic material on said plurality of pixel electrodes 115.

Preferably, the electrochromic characteristics of the electrodeposited organic electrochromic material and/or an organic polymer electrochromic material 125-127 are the characteristics of the material obtained by the electrodeposition and/or electropolymerization. The organic entities (e.g. monomers) that are added to the solution may or may not have electrochromic characteristics.

In an embodiment, the method of the invention is intended for the deposition of different organic electrochromic materials on different pixel electrodes, for example on different sub-groups of pixel electrodes. In this manner, it is possible to deposit electrochromic materials for color electrochromic devices, for example multi-color devices and even full-color electrochromic devices, such as the RGB display disclosed in FIG. 1. For example, the pixel may be grouped in subpixels, wherein a certain number of subpixels form one pixel, preferably three-subpixel forming one pixel, for example in accordance with the additive RGB principle discussed with respect to FIG. 1. In accordance with the invention, electrochromic material of a particular color may deposited on part of the pixel electrodes only, preferably on the subpixel electrodes of a particular color (red, green or blue, for example).

In a preferred embodiment of the method, said grid, array or matrix comprises a plurality of subpixel electrodes 115-117, wherein said method comprises providing an external driving device 209 configured to apply said electric potential between a first portion of said plurality of subpixel electrodes and said counter electrode 210, thereby providing the deposition and/or electropolymerization of said entities of said organic electrochromic material only on said first portion of said plurality of subpixel electrodes 115.

In a preferred embodiment, a defined number of subpixels is designed to provide an individual pixel of said electrochromic device, and wherein said first portion of subpixel electrodes encompasses only one or only part of the subpixels of said individual pixel. For example, in device using RGB additive colouring, three subpixels may form one pixel.

For example, referring to FIG. 2, the driving device 209 may be electronically controlled to apply a voltage potential only between pixel (or subpixel) electrode 115 and the counter electrode 210, but not between pixels (or subpixels) 116 and 117 and the counter electrode, so that the entities of the organic electrochromic material are deposited on pixel electrodes 115 only, but not on the other pixel electrodes 116 and 117.

The active matrix 220 shown is schematically shown in FIG. 2. There is a large number of pixel (or subpixel) electrodes present in an active matrix, the number depending on the size and resolution of the display. In an embodiment detailed above a pixel is formed by three subpixels, and reference numeral 115 may illustrate one subpixel electrode, and reference numerals 116, 117, the two other subpixel electrodes that will be present in one pixel of the final device. In this case, the active matrix preferably contains many subpixel electrodes 115, and an equal number of subpixel electrodes 116 and 117, only one of the plurality of subpixels being shown for illustration in FIG. 2. Accordingly, in the embodiment of the method of the invention, the entities of the organic electrochromic material are deposited on all (sub-)pixel electrodes 115, but not on the (sub-)pixel electrodes 116, 117 of the active matrix 220.

In FIG. 2, reference numeral 115 may thus represent a first portion of pixel or subpixel electrodes, and thus all pixels or subpixels of that portion. By analogy, reference numeral 116 may represent a second portion of pixel or subpixel electrodes, and reference numeral 117 may represent a third portion of pixel or subpixel electrodes.

For avoidance of doubt, the invention is not limited to a particular number of portions of (sub-) pixel electrodes. Three portions of pixel electrodes are shown for illustration only. The invention also encompasses electrochromic devices comprising only one type of pixel electrodes, all pixels having the same organic electrochromic material and thus having the same color characteristics. The invention also encompasses single color and/or black & white devices, for example.

All pixel electrodes (or subpixel electrodes) 115 may thus represent the first portion or part of the pixel electrodes on which said entities of said organic electrochromic material are deposited.

Preferably, the deposition of said entities is selected from the group consisting of: electrodeposition, polymerization, electropolymerization and a combination of two or more of the aforementioned. Preferably, the deposition of said entities corresponds to deposition by electropolymerization. Preferably, the deposition of said organic entities results in the deposition of said organic electrochromic material.

In the embodiment where said organic entities are deposited only on a portion of pixel electrodes or subpixel electrodes, said entities are preferably first entities of a first organic electrochromic material 125. Said first organic electrochromic material has preferably a first color. Similarly, said solution comprising said first entities of a first organic electrochromic material is preferably a first solution.

It is noted that said “first color” depends on the redox status of said first organic electrochromic material. The expression “first color” may be understood as “first electrochromic color characteristics”, and the same applies per analogy to “second color” and “third color”. In the same line, the expression “different color”, is preferably understood as “different electrochromic color characteristics”. One may also say that “the first color” refers to the “first light modulating properties”, it is understood that “the second color” refers to light modulating properties that are different from said first light modulating properties, in particular with respect to the color of the light that is modulated.

In an embodiment, the method of the invention comprises:
immersing said grid or matrix 220 in a second solution,
adding second entities of a second organic electrochromic material to said second solution, wherein said first and second entities are different,
applying an electric potential between a second portion of said plurality of pixel or subpixel electrodes and said counter electrode 210, thereby providing the deposition of said second entities of said second organic electrochromic material 126 on said second portion of said plurality of pixel or subpixel electrodes,

wherein said first and second organic electrochromic material have a different color.

As with respect to the deposition of an organic electrochromic material on a first portion of said pixel or subpixel electrodes, the features of immersing said grid or matrix in a second solution and adding second entities of an organic electrochromic material may be conducted timely independently from each other. These features may be replaced by “providing a solution comprising said second entities, said grid or matrix 220 and said counter electrode 210”. Preferably, at this stage, the first organic electrochromic material 125 has already been deposited on the first portion of pixel or subpixel electrodes.

Furthermore, applying the voltage potential only between said second portion of pixel or subpixel electrodes 116, but not on said first portion 115 and not on a possible third portion 117, is preferably conducted using the external driver 209.

The deposition of said second entities of said second organic electrochromic material 126 on said second portion of said plurality of pixel or subpixel electrodes preferably results in the electrodeposition and/or electropolymerization of said second organic electrochromic material. The latter material is thus preferably formed by said electrodeposition and/or electropolymerization.

In an embodiment, the method comprises rinsing said grid or matrix 220 before immersing said grid or matrix in said second solution and preferably after removing said grid or matrix from said first solution.

In an embodiment, the method of the invention comprises:
immersing said grid or matrix 220 in a third solution,
adding third entities of a third organic electrochromic material 127 to said third solution,
applying an electric potential between a third portion 117 of said plurality of pixel or subpixel electrodes and said counter electrode 210, thereby providing the deposition of said third entities of said third organic electrochromic material 127 on said third portion 117 of said plurality of pixel or subpixel electrodes,

wherein said first, second and third entities are all different from each other, and wherein said first, second and third organic electrochromic materials 125-127 have a different color.

As detailed above with respect to the deposition of a second organic electrochromic material, the features of immersing said grid or matrix in a third solution and adding entities of a third organic electrochromic material may be conducted timely independently from each other. These features may be replaced by providing a solution comprising said third entities and said grid or matrix. Furthermore, applying the voltage potential only between said third portion of pixel or subpixel electrodes 117, but not on said first portion 115 and not on a second portion 116, is preferably conducted using the external driver 209.

In an embodiment, the method of the invention comprises rinsing said grid or matrix before immersing said grid or matrix in said third solution and preferably after removing said grid or matrix from said second solution.

The invention also provides a method for producing an electrochromic device in accordance with the invention, preferably an electrochromic display. In order to produce the device, organic electrochromic materials are deposited on array (or pixel or subpixel) electrodes in accordance with the aspects and preferred embodiments disclosed in this specification. Further components of the device are then assembled. Such further components comprise a counter electrode preferably comprising an ion storage layer and an ion transport layer. Preferably, an active matrix is provided in said device as disclosed with respect to the deposition of the organic electrochromic material. Other preferred components of the device are first and/or second substrates 100, 110. Such devices may be assembled as is conventional.

For the avoidance of doubt, it is noted the terms pixels and subpixels are considered to be exchangeable in that reference to a pixel may encompass reference to a subpixel. The term subpixel is relevant basically in multi- or full color devices, when three independently addressable elements are perceived by a human observer as a spot having a particular color when seen from a certain distance from the device. The particular color of a pixel may thus be created by several separate but spatially close subpixels. The distinction between pixel and subpixel does not necessarily imply structural or other technical differences. In particular, in the figures, elements 105-107 are individually and independently addressable elements having the structure as described, independently of the elements being considered as “pixels”, “subpixels”, layered structures, arrangements, for examples, or otherwise. The aforementioned terms may thus be exchangeably used for referring to structures 105-107.

### Example: Production of Full-Color Electrochromic Display

A full-color electrochromic display based on electropolymerization of red, green and blue electrochromic materials on different sub-pixel electrodes is produced as described below.

1. Working Electrode Preparation:

An active-matrix thin film transistor (AM-TFT) backplane is used as a working electrode. Adequate electrical connections are wired out, providing different groups of sub-pixels that are independently addressed. While a group of sub-pixels are addressed, the channels of that group of sub-pixels are activated so that a desired voltage could be applied on the corresponding pixel electrodes. For other groups of sub-pixels which are not addressed, the voltage of the pixel electrodes remains floating and there is no current supplied.

The AM-TFT backplane is inserted vertically into a tank facing an ITO glass substrate as a counter electrode (in other examples, a carbon felt or a platinum mesh are used as a counter electrode). The tank is filled with a solution comprising monomers suitable to form the electrochromic organic polymer which is to be deposited on the pixel electrodes, an electrolyte and a solvent mixture.

For realizing the full-color electrochromic display red, green and blue electrochromic polymer are sequentially electropolymerized of on one-third of the sub-pixel electrodes, resulting in each pixel containing three sub-pixels of red, green and blue electrochromic polymer materials.

For the deposition of the red electrochromic materials, a solution of 10 mM of 3,10-bis(2,3-dihydrothieno[3,4-b][1,4]dioxin-5-yl)-1-dodecyl-1H-phenanthro[1,10,9,8-c,d,e,f,g]carbazole (short as DEP) with 0.1 M tetrabutylammonium hexafluorophosphate (TBAPF6) in acetonitrile is used. Cyclic voltammetry method is used for conducting the electropolymerization. An Ag/AgCl standard reference electrode is used, and the voltage between the red pixel electrodes and the reference electrode are swept between −0.3V and 1.1V with a scanning rate of 100 mV/s. The scanning cycle number is 10. During the electropolymerization of red electrochromic polymer, only the red sub-pixel electrodes are applied with the desired voltage while green and blue sub-pixel electrodes are not addressed. The AM-TFT backplane is removed from the tank, rinsed with de-ionized water and dried with compressed air or nitrogen gun.

For the deposition of the green electrochromic polymer, a solution of 2 mM 5,8-bis(2,3-dihydro[3,4-B][1,4]dioxin-5-yl)-2,3-dual(4-(hexadecyloxy) phenyl)quinoxaline (short as BOPEQ) with 0.1 M TBAPF6 in acetonitrile/dichloromethane (volume ratio: 8/2) is used. Cyclic voltammetry with sweeping voltage between −0.6 V and 1.1V, scanning rate of 100 mV/s and cycle number of 10 is used for conducting the electropolymerization. After completing the deposition process, the AM-TFT backplane is removed from the tank, and cleaned and dried as described above.

For the deposition of the blue electrochromic polymer, a solution of 1 mM 5,5′-(3,6-diphenylthieno[3,2-b]thiophene-2,5-diyl)bis(2,3-dihydrothieno[3,4-b][1,4]dioxine) with 0.1 M TBAPF6 in acetonitrile/dichloromethane (volume ratio: 1/3) is used. The sweeping voltage between −0.8 V and 1.4V with scanning rate of 100 mV/s for 10 cycles is used for conducting the deposition by electropolymerization.

2. Antimony Doped Tin Oxide (ATO) Paste Preparation:

ATO mesoporous film is used as an ion storage layer on the counter electrode. The ATO paste is prepared as follows:

10.5 g of antimony doped tin oxide (ATO) nanopowder (Alfa Aesar, particle size: 13-22 nm) is suspended in ethanol (400 ml) and sonicated for 1 hour with a horn sonicator. The resulting colloidal solution is mixed with 33 g ethyl cellulose solution (5% wt in ethanol:toluene 20:80 vol %) and 40 g terpineol respectively. The colloidal mixture is vigorously stirred for 30 minutes, followed by ethanol removal under reduced pressure (max. 60° C.).

3. Counter Electrode Preparation:

An ITO substrate is used for preparing the counter electrode (in another example, a FTO substrate is used). The ATO paste is printed on the ITO substrate by screen printing. After the printing, the electrode is sintered at 450° C. for 30 min with a slow ramping speed of 10° C./min from ambient temperature to avoid crack formation. The thickness of the sintered ATO mesoporous film is about 3 μm.

4. Electrolytic Solution Filling and Assembly:

An electrolytic solution is prepared by mixing lithium bis(trifluoromethanesulfonyl)imide, 4-Cyano-4′-pentylbiphenyl and sulfolane (weight ratio=75:500:18). The assembly is performed by a standard one drop filling instrument widely used in liquid crystal display (LCD) industries. The UV curing glue is dispensed along the edge of the working electrode. The sphere spacer of 10 um diameter is sprayed uniformly over the working electrode surface. Precise amount of electrolytic solution is dispensed within the frame of the sealing glue. The amount of electrolytic solution is calculated to perfectly fill the gap volume between working and counter electrodes. The counter electrode is then brought into contact with the sealing glue frame, further stopped by the sphere spacer. The glue is then cured with UV light. A full-color electrochromic display is thus completed.

While certain of the preferred embodiments of the present invention have been described and specifically exemplified above, it is not intended that the invention be limited to such embodiments. Various modifications may be made thereto without departing from the scope and spirit of the present invention, as set forth in the following claims. Herein below, examples of the invention are disclosed. These examples are for illustration only and are not intended to limit the scope of the present invention.

1. A full-color electrochromic device comprising:
a plurality of pixels, wherein each pixel comprises first, second and third subpixels, wherein each subpixel comprises a subpixel electrode and an organic electrochromic material, wherein said first subpixel comprises a first electrochromic material, wherein said second subpixel comprises a second organic electrochromic material, and wherein said third subpixel comprises a third organic electrochromic material, said first, second and third organic electrochromic materials having different colors;
a first substrate comprising an active matrix comprising electrically conducting lines and active components, for providing electrical current to said subpixel electrodes, wherein an active component is provided for each of said subpixels, wherein one active component is electrically connected to one subpixel electrode, and wherein a predetermined subpixel electric potential is established via said active component;
a second substrate, wherein said first and second substrates have opposed first and second outside surfaces;
one or more counter electrode connected to said second substrate; and,
an ion conducting material for transporting ions between said subpixels and said one or more counter electrode;
wherein said electrochromic device is configured to establish an electric potential between any one specific subpixel and said one or more counter electrode, wherein said organic electrochromic materials are electrodeposited organic polymer electrochromic materials obtained by electropolymerization on said subpixel electrodes.

2. The electrochromic device of claim 1, comprising an insulating layer provided between said first substrate and said subpixel electrodes, wherein said subpixel electrodes are preferably deposited on said insulating layer, wherein said active matrix comprises electrically conducting vias extending across said insulating layer, and wherein a via is provided to connect an individual active component with an individual subpixel electrode.

3. The electrochromic device of claim 1, wherein said first subpixel comprises an organic electrochromic material having a red color when exposed to a particular voltage, said second subpixel comprises an organic electrochromic material having a green color when exposed to a particular voltage, and said optional third subpixel comprises an organic electrochromic material having a blue color when exposed to a particular voltage.

4. The electrochromic device of claim 1, wherein said ion conducting material comprises one or both selected from a liquid crystal and an ionic liquid crystal.

5. The electrochromic device of claim 1, wherein said ion conducting material is provided within a common space, wherein at least three separate subpixels are provided within said common space and/or are in contact with a continuous ion conducting material.

6. The electrochromic device of claim 1, wherein said ion conducting material is provided within a common space, wherein a plurality of pixels is provided within said common space and/or are in contact with a continuous ion conducting material.

7. The electrochromic device of claim 1, wherein said electrodeposited organic material comprises one or more selected from the group consisting of: electrodeposited viologen, electrodeposited triphenylamine, electrodeposited thiophene, electrodeposited 3,4-ethylenedioxythiophene, electrodeposited pyridine, electrodeposited aniline, electrodeposited imides, electrodeposited aromatic ketones, electrodeposited anthraquinone, electrodeposited amides, electrodeposited norbornene-based compounds, electrodeposited carbazoles, electrodeposited thiocarbazoles, electrodeposited pyrol, and electrodeposited derivatives of the aforementioned.

8. The electrochromic device of claim 1, wherein said polymerized organic material comprises one or more selected from the group consisting of polyviologen, polytriphenylamine, polythiophene, poly, polypyridine, polypyrol, polyaniline, polyimides, polymeric aromatic ketones, polyanthraquinone, polymeric heterocycles, polyamides, polynorbornene, polycarbazoles, polythiocarbazoles and their derivatives.

9. The electrochromic device of claim 7, wherein said derivative is a material comprising the basic structure of the indicated organic material and optionally further comprising one or more substituents, which substituents are selected independently from organic substituents comprising from 1-50 carbons and 0-20 heteroatoms, preferably 1-20 carbons and 0-10 heteroatoms, most preferably 1-10 carbons and 0-5 heteroatoms.

10. The electrochromic device of claim 9, wherein said one or more substituents are selected from aliphatic and aromatic substituents, esters and amines of aliphatic and aromatic moieties, wherein in said aliphatic or aromatic substituent or moiety one or more hydrogens are optionally replaced independently by one or more selected from phosphonate (—PO(OH)₂), boronic acid (—B(OH)₂), —OH, —COOH, —NH₂, —NO₂, aminoxide —N⁺(R)₂—O⁻), halogen, and —(CH₂)ₙ—Si(OR₃)₃. R and R₃ are independently selected from C1-C10 alkyl, preferably C1-C5 alkyl.

11. A method for depositing an organic electrochromic material on pixel electrodes of an electrochromic device, the method comprising:
providing an active matrix comprising a first substrate, electrically conducting lines, active components and a plurality of subpixel electrodes, wherein said active matrix comprises a specific line for each of said subpixel electrodes,
immersing said active matrix in a first solution,
adding first monomeric entities to said first solution,
immersing a counter electrode in said first solution,
providing an external driving device,
applying an electric potential between a first portion of said plurality of subpixel electrodes and said counter electrode, so as to electropolymerize said first monomeric entities on said first portion of said plurality of subpixel electrodes, and thereby deposit a first organic polymer electrochromic material having a first color on said first portion of subpixel electrodes,
immersing said active matrix in a second solution,
adding second monomeric entities to said second solution,
applying an electric potential between a second portion of said plurality of subpixel electrodes and said counter electrode so as to electropolymerize said second monomeric entities on said second portion of said plurality of subpixel electrodes and thereby deposit a second organic polymer electrochromic material having a second color on said second portion of subpixel electrodes,
immersing said active matrix in a third solution,
adding third monomeric entities to said third solution,
applying an electric potential between a third portion of said plurality of subpixel electrodes and said counter electrode so as to electropolymerize said third monomeric entities on said third portion of said plurality of subpixel electrodes, and thereby deposit a third organic polymer electrochromic material having a third color on said third portion of subpixel electrodes,
wherein said first, second and third monomeric entities are different from each other, wherein said first, second and third organic electrochromic materials have a different color, and wherein said first, second and third portions of subpixel electrodes are different portions of the active matrix, wherein a pixel electrode is formed from three subpixel electrodes in which each subpixel electrode comprises a different electrochromic material.

12. The method of claim 11, which comprises rinsing said active matrix before immersing said active matrix in said second solution and preferably after removing said active matrix from said first solution.

13. The method of claim 11, which comprises rinsing said active matrix before immersing said active matrix in said third solution and preferably after removing said active matrix from said second solution.

14. The method of claim 11, wherein said active matrix comprises thin film transistors, wherein every subpixel of said electrochromic device comprises an individual TFT for controlling current flow towards or from an individual subpixel electrode.

15. The method of claim 11, wherein an insulating layer is provided between said first substrate and said subpixel electrodes, wherein said subpixel electrodes are preferably deposited on said insulating layer, wherein said active matrix comprises electrically conducting vias extending across said insulating layer, and wherein a via is provided to connect an individual active component with an individual, corresponding subpixel electrode.

16. The method of claim 11, comprising:
assembling a counter electrode and an ion transport material in order to provide said electrochromic device.

17. The method of claim 16, wherein said ion transport material comprises one or both selected from a liquid crystal and an ionic liquid crystal.

18. The electrochromic device of claim 1, which lacks separation walls, parts, borders and/or regions parts for electrically separating the pixels and/or subpixels.

19. The method of claim 11, which lacks separation walls, parts, borders and/or regions parts for electrically separating the pixels and/or subpixels.
